(19) United States
(12) Patent Application Publication
(10) Pub. No.: US 2002/0166104 A1
(43) Pub. Date: Nov. 7, 2002

(54) System and method for alternative wiring using pre-analyzed patterns

(76) Inventors: Yu-Liang Wu, Shatin (HK); Hongbing Fan, Victoria (CA)

Correspondence Address: Chiahua George Yu, Law Offices of C. George Yu, Ste. 210, 1250 Oakmead Pkwy., Sunnyvale, CA, 94085, US

(21) Appl. No.: 10/023,435

(22) Filed: Dec. 14, 2001

Related U.S. Application Data
(60) Provisional application No. 60/255,853, filed on Dec. 14, 2000.

(51) Int. Cl. G06F 17/50

(52) U.S. Cl. 716/12; 716/13; 716/14

(57) ABSTRACT

An alternative wiring scheme uses information about pre-analyzed logic patterns to determine alternative wires for new logic networks. Preferably, no Boolean implication is used.

### CROSS REFERENCE TO RELATED APPLICATIONS

This claims the benefit of priority from commonly-owned U.S. Provisional Patent Application No. 60/255,853, filed on Dec. 14, 2000, entitled “System and Method for Graph-based Alternative Wiring for Boolean Logic”, which are hereby incorporated by reference in their entireties for all purposes.

### BACKGROUND OF THE INVENTION

The present invention relates to Computer-Aided Design (CAD) for circuitry, especially for Very Large Scale Integration (VLSI) circuitry. Such CAD is also referred to as Electronic Design Automation (EDA). The present invention is especially relevant to Alternative Wiring (AW) and to EDA that involves AW.

VLSI design is typically considered to include the stages of high-level design, logic synthesis, and physical design. In high-level design, desired system behavior and functions are specified and are embodied into a relatively high-level hardware description using a relatively high-level description language. In logic synthesis, the relatively high-level description is translated into a logic design, e.g., a set of technology-specific gates and interconnects, or netlist. In physical design, the logic design is used to generate an actual physical layout. Physical design typically includes circuit partitioning, floor planning, placement, and routing.

Recently, as the size scale of chip features continues to shrink and the overall size and transistor count of VLSI chips continue to increase, the physical design problem is becoming ever more difficult. The result is that logic designs verified in the logic synthesis stage now much more frequently than ever cause physical design failures. Such failures may include, for example, incomplete routing and/or timing violations. When such failures occur, the logic design typically is altered in hopes of producing an equivalent logic design that can be successfully laid out physically by the physical design stage. One recently developed approach that is of use in such post-layout logic restructuring is AW. More generally, AW is useful not only for post-layout logic restructuring but also for a wide range of applications including, for example, optimization of circuits, of circuit timing, of circuit partitioning, and of Field Programmable Gate Array (FPGA) synthesis.

AW is an approach in which a redundant connection is added to a design so that an existing target connection is made redundant and can therefore be removed from the design without changing the functionality of the design. Choice of the target connection is according to the demands and methodologies of the particular application. For example, depending on the application, an existing un-routable connection, or an existing connection along a too-long critical path, or connections that are cut by an existing partitioning may be good target connections for attempted replacement.

Conventional AW methods use Boolean implication in their analyses. Boolean implication refers to, for example, Boolean reasoning to determine signal value assignments, or constraints on such assignments, based on other known or hypothesized signal value assignments. Whatever terminology is used to describe the techniques underlying conventional AW methods (e.g., recursive learning, Automatic Test Pattern Generation (ATPG), mandatory assignment, logic implication, Fault-Independent Combinational Redundancy Identification (FIRE), indirect Boolean implication, etc.), the conventional AW methods use Boolean implication.

A popular and highly-regarded AW system is Redundancy Addition-and-removal for Multilevel Boolean Optimization (RAMBO). (See, Kwang Ting Cheng and Luis A. Entrena, “Multi-Level Logic Optimization By Redundancy Addition And Removal”, in Proceedings of European Conference on Design Automation, with the European Event in ASIC Design, pp. 373-377, February 1993; and D. I. Cheng, C. C. Lin, and M. Marek-Sadowska, “Circuit Partitioning With Logic Perturbation, in Proceedings of IEEE International Conference on Computer-Aided Design, pp. 650-655, 1995.) Like other conventional AW methods, RAMBO uses Boolean implication in determining alternative wires.

A common and major problem with the conventional AW methods is that they run slowly mainly due to the time-consuming nature of their underlying Boolean implication techniques. For example, the RAMBO method typically considers a large number of candidate wires for each target wire that is sought to be replaced. Then, the RAMBO method applies Boolean implication (in ATPG) in determining whether some of the candidate wires actually succeed in making the target wire redundant. This determining by the RAMBO method and similar determinings by other methods are intrinsically computationally expensive. In particular, the size of the candidate wire set contributes a polynomial factor to the run time. Furthermore, recursive learning is exponential in nature. In fact, the existence problem of an alternative wire for a target wire is intrinsically NP-complete, even for relatively small sub-circuits. Even though RAMBO does achieve some level of useful efficiency by limiting the domain of its implication processes, RAMBO and other conventional methods are still quite slow to run.

### SUMMARY OF THE INVENTION

What is needed is a system and a method for performing AW that is faster than RAMBO or faster than other conventional AW systems and methods. For example, what is needed is such a system and method that can propose a valid alternative redundant wire for a given target wire and a given design without using Boolean reasoning. Such system and method is especially suited to and preferred for EDA for sub-micron and deep sub-micron circuit feature sizes.

According to one embodiment of the present invention, in an information processing system, a method for alternative wiring for logic design includes: maintaining information descriptive of alternative wiring for each of multiple predetermined logic patterns; for a logic network, determining a portion of the logic network as corresponding to one of the multiple predetermined logic patterns; and determining an alternative wire for the logic network based on information maintained in the maintaining step that is descriptive of alternative wiring for the one of the multiple predetermined logic patterns.

According to another embodiment of the present invention, a system for alternative wiring for logic design includes: means for maintaining information descriptive of alternative wiring for each of multiple predetermined logic patterns; means for determining, for a logic network, a portion of the logic network as corresponding to one of the multiple predetermined logic patterns; and means for determining an alternative wire for the logic network based on information maintained by the means for maintaining that is descriptive of alternative wiring for the one of the multiple predetermined logic patterns.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative

FIG. 1 is a schematic block diagram that illustrates a computer system that may be used for implementing the present invention.

FIG. 2 is a schematic block diagram that illustrates a software system for controlling the computer system of FIG. 1.

FIGS. 3A-3C are a schematic logic diagrams that illustrate an example of an alternative wiring logic transformation.

FIGS. 3D-3F are schematic block diagrams that illustrate example applications of AW to achieve particular design and optimization goals.

FIG. 4 is a schematic flow diagram that illustrates a method for determining an alternative wire, according to some embodiments of the present invention.

FIG. 5 is a schematic flow diagram that illustrates a method for determining an alternative wire, according to some embodiments of the present invention.

FIG. 6 is a schematic block diagram of an AW system according to the present invention.

FIG. 7 is a schematic flow diagram that illustrates a method according to an embodiment of the present invention, that maintains and uses AW-relevant knowledge of logic building blocks in order to much more efficiently and quickly determine alternative wires for the logic networks built from the logic building blocks.

FIG. 8 is a schematic block diagram that illustrates an example logic design built using pre-analyzed logic building blocks with known AW properties.

FIG. 9 is a schematic logic diagram that illustrates a mapping of a sub-network of a logic network to various configurations.

FIG. 10 is a schematic logic diagram that shows transformation by reduction rules, in an embodiment of the present invention.

FIGS. 11-34 schematically illustrate an extensive set of useful pre-analyzed logic patterns that indicate alternative wires and target wires.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles below are terse and are for convenience only.

I. Computer-based Implementation

A. Basic System Hardware (e.g., for Server or Client Computers)

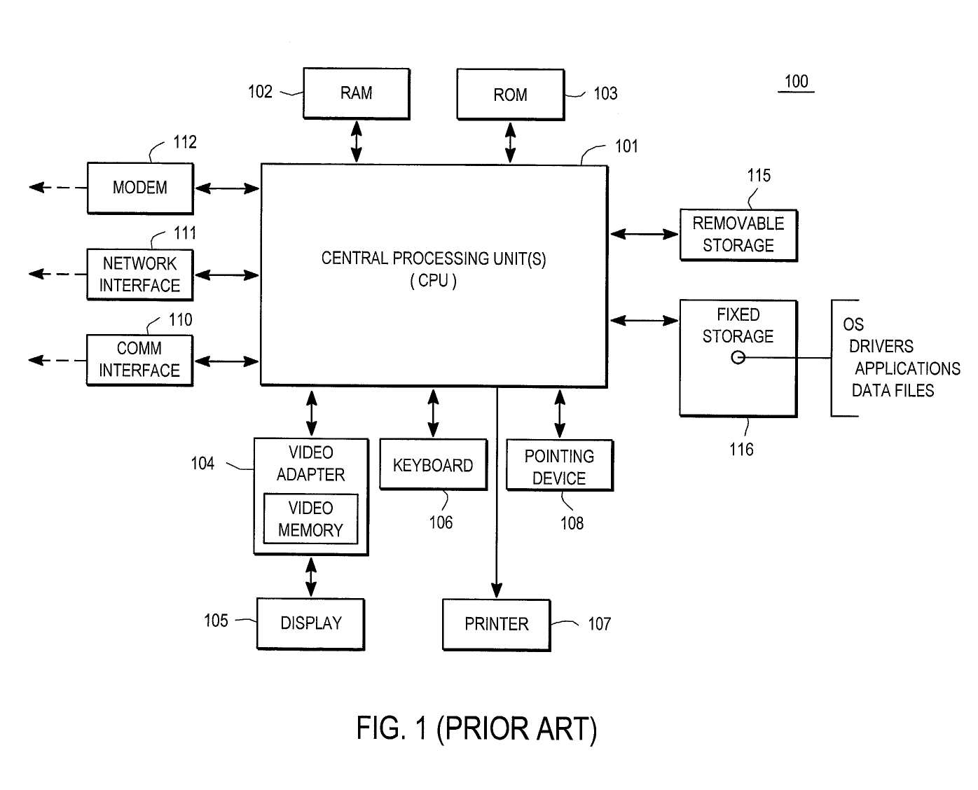

The present invention may be implemented using any competent computer system(s), for example, a Personal Computer (PC). FIG. 1 is a schematic diagram for a computer system 100. As shown, the computer system 100 comprises a central processor unit(s) (CPU) 101 coupled to a random-access memory (RAM) 102, a read-only memory (ROM) 103, a keyboard 106, a pointing device 108, a display or video adapter 104 connected to a display device 105 (e.g., cathode-ray tube, liquid-crystal display, and/or the like), a removable (mass) storage device 115 (e.g., floppy disk and/or the like), a fixed (mass) storage device 116 (e.g., hard disk and/or the like), a communication port(s) or interface(s) 110, a modem 112, and a network interface card (NIC) or controller 111 (e.g., Ethernet and/or the like). Although not shown separately, a real-time system clock is included with the computer system 100, in a conventional manner. The shown components are merely typical components of a computer. Some components may be omitted, and other components may be added, according to user choice.

The computer system 100 is utilized to receive or contain input. The computer system 100 then, under direction of software according to the present invention, operates upon the input according to methodology of the present invention to produce desired output, which are then displayed or otherwise output for use. The computer system 100, as shown and discussed, corresponds to merely one suitable configuration. Any other competent computer system and configuration is also acceptable.

The CPU 101 comprises a processor of the Pentium® family of microprocessors. However, any other suitable microprocessor or microcomputer may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory (RAM) 102 serves as the working memory for the CPU 101. In a typical configuration, RAM of at least sixty-four megabytes is employed. More or less memory may be used without departing from the scope of the present invention. The read-only memory (ROM) 103 contains the basic input output system code (BIOS)—a set of low-level routines in the ROM 103 that application programs and the operating systems can use to interact with the hardware, including reading characters from the keyboard, outputting characters to printers, and so forth.

Mass storage devices 115 and 116 provide persistent storage on fixed and removable media, such as magnetic, optical or magnetic-optical storage systems, or flash memory, or any other available mass storage technology. The mass storage may be shared on a network, or it may be a dedicated mass storage. As shown in FIG. 1, fixed storage 116 stores a body of programs and data for directing operation of the computer system, including an operating system, user application programs, driver and other support files, as well as other data files of all sorts. Typically, the fixed storage 116 comprises a main hard disk of the system.

In basic operation, program logic (including that which implements methodology of the present invention described below) is loaded from the storage device or mass storage 115 and 116 into the main memory (RAM) 102, for execution by the CPU 101. During operation of the program logic, the computer system 100 accepts, as necessary, user input from a keyboard 106, a pointing device 108, or any other input device or interface. The user input may include speech-based input for or from a voice recognition system (not specifically shown and indicated). The keyboard 106 permits selection of application programs, entry of keyboard-based input or data, and selection and manipulation of individual data objects displayed on the display device 105. Likewise, the pointing device 108, such as a mouse, track ball, pen device, or the like, permits selection and manipulation of objects on the display device 105. In this manner, the input devices or interfaces support manual user input for any process running on the computer system 100.

The computer system 100 displays text and/or graphic images and other data on the display device 105. The display device 105 is driven by the video adapter 104, which is interposed between the display 105 and the system. The video adapter 104, which includes video memory accessible to the CPU, provides circuitry that converts pixel data stored in the video memory to a raster signal suitable for use by a cathode ray tube (CRT) raster or liquid crystal display (LCD) monitor. A hard copy of the displayed information, or other information within the computer system 100, may be obtained from the printer 107, or other output device. Printer 107 may include, for instance, a Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The computer system 100 may also communicate with local occasionally-connected devices (e.g., serial cable-linked devices) via the communication interface 110, which may include a RS-232 serial port, a serial IEEE 1394 (formerly “firewire”) interface, a Universal Serial Bus (USB) interface, or the like. Devices that will be commonly connected locally to the communication interface 110 include other computers, handheld organizers, digital cameras, and the like. The system may accept any manner of input from, and provide output for display to, the devices with which it communicates.

The above-described computer system 100 is presented for purposes of illustrating basic hardware that may be employed in the system of the present invention. The present invention however, is not limited to any particular environment or device configuration. Instead, the present invention may be implemented in any type of computer system or processing environment capable of supporting the methodologies of the present invention presented below.

B. Basic System Software

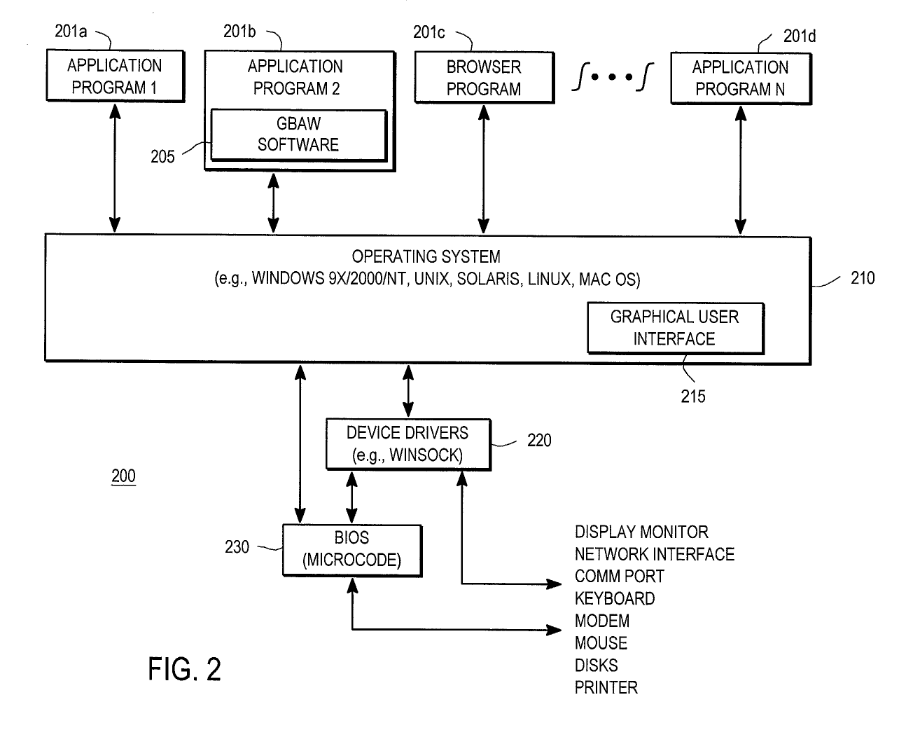

FIG. 2 is a schematic diagram for a computer software system 200 that is provided for directing the operation of the computer system 100 of FIG. 1. The software system 200, which is stored in the main memory (RAM) 102 and on the fixed storage (e.g., hard disk) 116 of FIG. 1, includes a kernel or operating system (OS) 210. The OS 210 manages low-level aspects of computer operation, including managing execution of processes, memory allocation, file input and output (I/O), and device I/O. One or more application programs, such as client or server application software or “programs” 201 (e.g., 201a, 201b, 201c, 201d) may be “loaded” (i.e., transferred from the fixed storage 116 of FIG. 1 into the main memory 102 of FIG. 1) for execution by the computer system 100 of FIG. 1.

The software system 200 preferably includes a graphical user interface (GUI) 215, for receiving user commands and data in a graphical (e.g., “point-and-click”) fashion. These inputs, in turn, may be acted upon by the computer system 100 in accordance with instructions from the operating system 210, and/or client application programs 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver) and the system BIOS microcode 230 (i.e., ROM-based microcode), particularly when interfacing with peripheral devices. The OS 210 can be provided by a conventional operating system, such as a Unix operating system, such as Red Hat Linux (available from Red Hat, Inc. of Durham, N.C., U.S.A.). Alternatively, OS 210 can also be another conventional operating system, such as Microsoft® D Windows (available from Microsoft Corporation of Redmond, Wash., U.S.A.) or a Macintosh OS (available from Apple Computers of Cupertino, Calif., U.S.A.).

Of particular interest, the application program 201b of the software system 200 includes software code 205 according to the present invention for providing or using AW using pre-determined patterns, as is further described. AW using pre-determined patterns may be referred to as Graph-based AW (GBAW). For convenience, specific embodiments of AW using pre-determined patterns are, and have been, sometimes referred to as GBAW. However, the true scope of the present invention is greater than merely the specific embodiments.

II. Further Introduction and Illustration of AW

A. Target Wires

In some AW methods, alternative wires are generated for a logic design without initially having a specific target wire that is sought to be replaced. However, AW has much more usefulness when it can start with a given target wire and attempt to find an alternative wire to replace the target wire. In particular, such AW fulfills the goal of engineering change by minimizing the amount of logic design changes only to a problematic local area (e.g., the target wire's local area). Accordingly, the preferred embodiment of the present invention is preferably used in a manner that directs its search, as will be discussed, to finding alternative wire(s) only for given target wires. However, in general, the present invention need not be limited so.

B. A Logic-Minimization Example

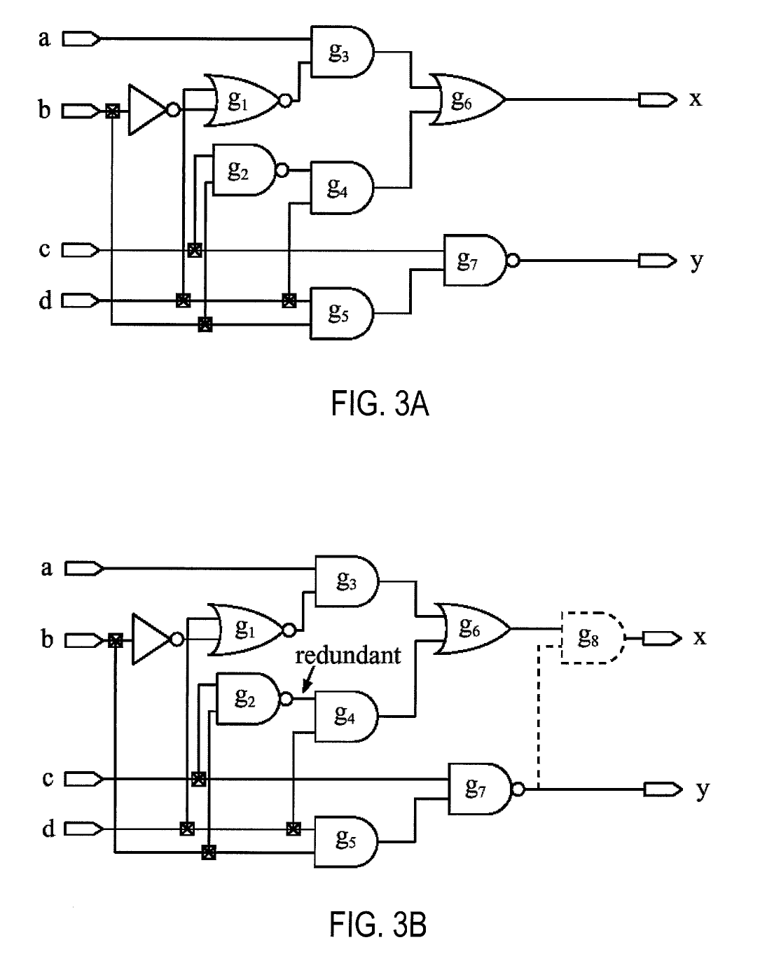

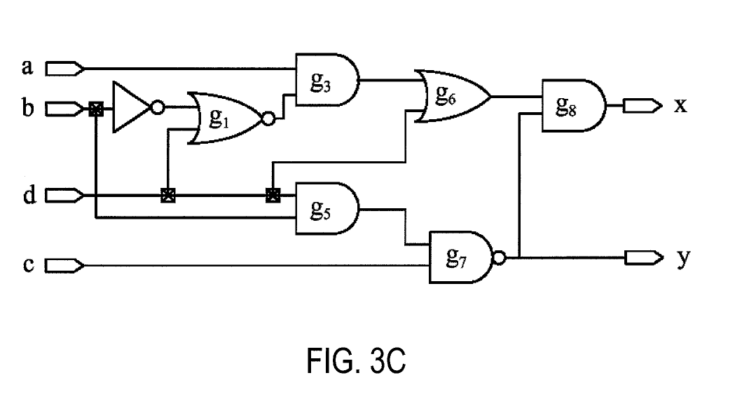

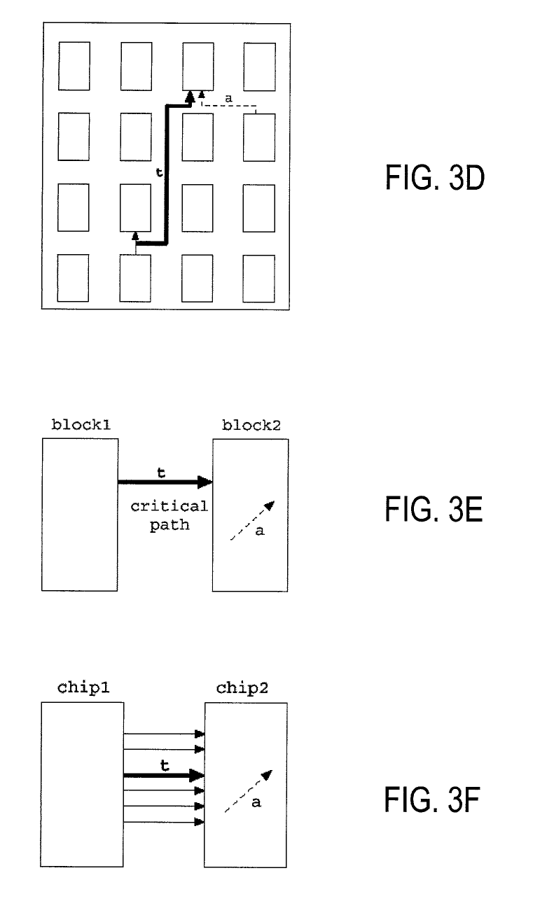

FIGS. 3A-3C are a schematic logic diagrams that illustrate an example of an alternative wiring logic transformation. FIGS. 3A-3C show an example of logic minimization using AW. FIG. 3A shows an irredundant circuit. The additional connection (g7, x) with an AND gate g8 in FIG. 3B is redundant, and the new connection makes the originally irredundant wire (g2, g4) redundant. After removing the connection (g2, g4), a new circuit with the same functionality but much simplified is obtained, as shown in FIG. 3C. The connection (g7, g8) is referred to as the alternative wire of connection (g2, g4).

C. An Example of Layout-Driven Logic Transformation

FIGS. 3D-3F are schematic block diagrams that illustrate example applications of AW to achieve particular design and optimization goals. FIG. 3D shows an example of layout-driven logic transformation for improving or enabling routability. In FIG. 3D, the thick line t represents an un-routable and long wire. Its alternative wire “a” is routable and shorter. Accordingly, replacing the long wire t with its shorter alternative wire “a” is likely to improve routability and reduce delay in the circuit. Such layout-driven logic transformations are useful, for example, in the logic synthesis of, for example, FPGAs.

D. An Example of Timing-Driven Logic Transformation

FIG. 3E shows an example of timing-driven logic transformation. In FIG. 3E, a connection t is on a critical path and connects two functional blocks, block1 and block2. The connection t has an alternative wire “a” that is shorter and that does not connect two functional blocks. Accordingly, replacing the connection t with its alternative connection “a” reduces the critical path delay.

E. An Example of Partition-Driven Logic Transformation

FIG. 3F shows an example of partition-driven logic transformation. In FIG. 3F, a wire t violates the pin constraints of chips chip1 and chip2. The wire t has an alternative wire “a” that does not span the two chips. Accordingly, replacing the connection t with its alternative connection “a” reduces the number of chip-to-chip connections and thereby increases the flexibility and perhaps the feasibility of partitioning.

F. AW Has a Large Number and Variety of Applications

As can be seen from the above-discussed examples, quite a number and variety of applications exist for AW. Most typically, the particular application identifies some target connections for attempted replacement according to the particular goals of the application. For example, unroutable connections, critical-path connections, connections spanning a cut, long connections, and the like might be chosen, depending on the particular EDA application. Once a target connection is chosen, then any AW engine might be called to attempt to determine alternative connections. Given a set of one or more alternative wires, the particular EDA application would evaluate them at an appropriate time according to criteria, e.g., a cost function evaluation, that is appropriate for the particular goal. For example, for timing-driven logic transformation, a cost function may be, or may prominently include, a path delay, especially a critical-path delay. For example, for partition-driven logic transformation, a cost function may be, or may prominently include, the number of cut wires. Other cost functions would be apparent, given the particular goal of the particular application.

Embodiments of the present invention provide an AW method and engine that is faster than conventional Boolean implication-based AW methods and engines by over an order of magnitude while being capable of identifying comparably as many alternative wires as the conventional AW methods. Such advanced performance is due, for example, to avoiding Boolean implication, which is slow.

III. Overview of AW Using Pre-Analyzed Logic Patterns

A. Topological Locality of, and Limited Patterns of, Alternative Wires

It may be informative to discuss some of the motivations underlying some embodiments of the present invention. Some embodiments of the present invention take advantage of an observations by the present inventors that the a very large proportion of alternative wires are located quite near the preexisting wires that they make redundant—e.g., within two edges of their target wires in a logic design in which gates are represented as nodes and wires are represented as edges. (Inverters are preferably not considered to be gates/nodes in this scheme, but are considered to indicate polarities of edges.) Motivated by this result, the present inventors determined that a relatively small number of local sub-network patterns are repeatedly encountered in practice. These sub-network patterns account for a remarkably large proportion of all alternative wires that are typically found by conventional Boolean implication-based AW methods. Such local patterns can even account for alternative wires that are not typically found by the faster conventional AW methods. As an illustration of the power of such local patterns, some embodiments of the present invention use only such local patterns (as will be further discussed) without performing Boolean implication at all. Despite not performing Boolean implication at all, these embodiments of the present invention can still find about 96% of the alternative wires that can be found by the much slower RAMBO AW method for the target wires of a standard database of test logic.

B. Pre-Analyzed Sub-Network Patterns Indicate Alternative Wires

The remarkably small number of local sub-network patterns necessarily indicate the existence of an alternative wire at a specific place in the pattern and indicates the specific preexisting wire(s) that is made redundant by the alternative wire. (As a matter of terminology, to say that an alternative wire exists is to say that there is a place where an alternative wire may be placed, if desired.) Thus, according to some embodiments of the present invention, once such local sub-network patterns have been analyzed once, for example, using any conventional Boolean implication-based AW method, then in the future, a given arbitrary logic design is no longer analyzed using Boolean implication. Instead, merely a graph of the given arbitrary logic design is searched, and preferably merely in a small area around a target wire, using ordinary graph searching techniques. The search is for the occurrence of any of a set of pre-analyzed local sub-network patterns. In this way, the computationally costly and slow Boolean implication can be avoided altogether.

The just described functionality of some embodiments of the present invention is, and has been, referred to as a form of Graph-Based Alternative Wiring (GBAW). If, for some reason, a particular EDA application or AW implementation still wishes to perform some Boolean implication, for example, in some special manner or for some special purpose, then the GBAW results can still be used as a complement or as a starting point so that whatever Boolean implication steps are still taken can be substantially reduced relative to the conventional Boolean implication-based AW methods when GBAW is not used at all. For example, even if some Boolean implication is desired to be used in conjunction with GBAW, then still no more than 19/20, or no more than 9/10, or no more than ½ of the time spent to find the alternative wire for a target wire is spent performing steps for Boolean implication, on average for at least a logic design for a user.

IV. Performing AW Without Using Boolean Implication

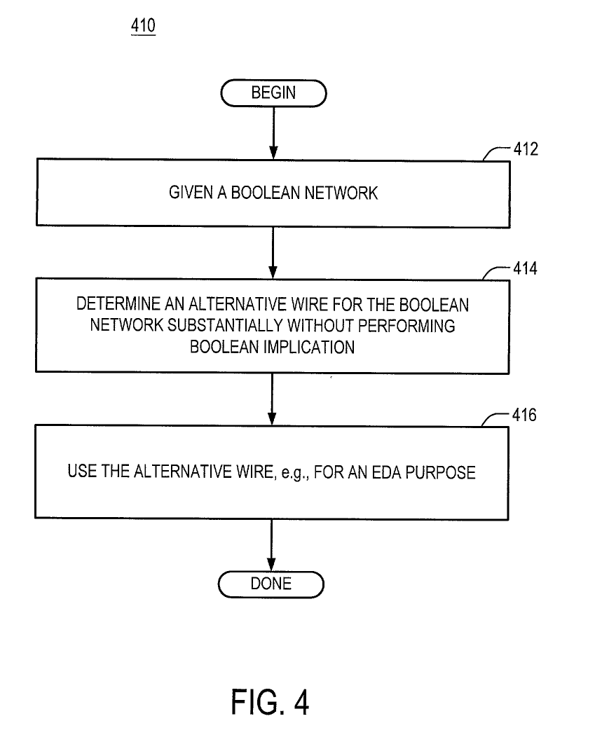

FIG. 4 is a schematic flow diagram that illustrates a method 410 for determining an alternative wire, according to some embodiments of the present invention. As shown in FIG. 4, in a step 412, there is received or possessed a specification that is indicative of a Boolean network, or at least a portion of a Boolean network. In a step 414, an alternative wire is determined substantially without performing Boolean implication. Preferably, no Boolean implication is performed at all for determining the alternative wire. Alternatively, however, as discussed above some amount of Boolean implication may be performed, but preferably no more than 9/10, or no more than ½ of the time spent to find the alternative wire for a target wire is spent performing steps for Boolean implication, on average for at least a logic design for a user. Preferably, the step 414 is undertaken for a particular specified target wire. The determined alternative wire is capable of being inserted into the Boolean network to thereby make an existing wire of the Boolean network redundant. Then, in a step 416, the determined alternative wire is used, for example within an EDA system for an EDA application, for example, one or more of the applications that are discussed above and below.

V. Using Pre-Analyzed Logic Patterns for AW

A. Methodology for Using Pre-Analyzed Logic Patterns for AW

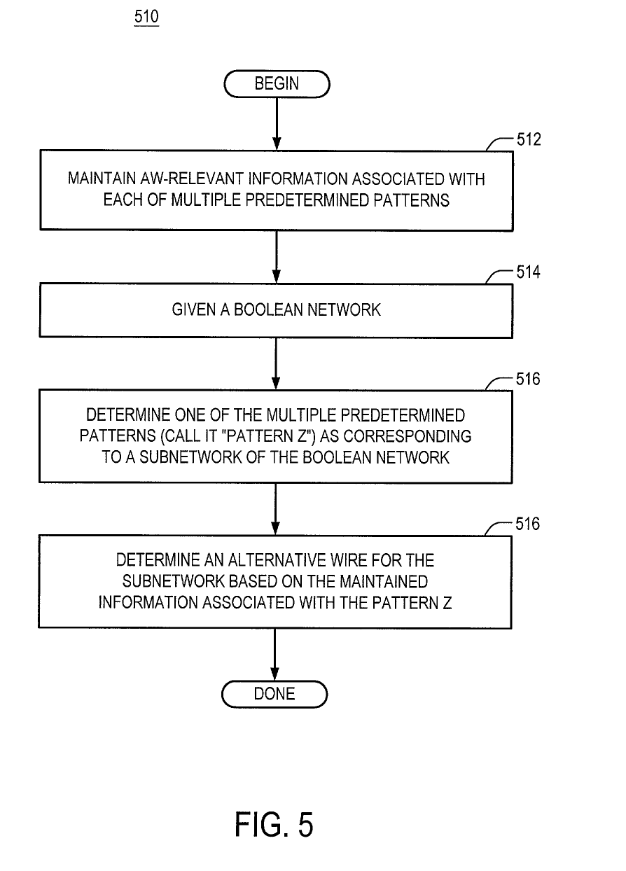

FIG. 5 is a schematic flow diagram that illustrates a method 510 for determining an alternative wire, according to some embodiments of the present invention. As shown, in a step 510, AW-relevant information is maintained that is associated with each of multiple predetermined design patterns. In a step 514, there is received or possessed a specification that is indicative of a Boolean network, or at least a portion of a Boolean network. Preferably, there is also received or possessed one or more designated target wire(s). In a step 516, it is determined whether one of the predetermined design patterns (call it pattern Z) corresponds to a sub-network of the Boolean network. If so, then in a step 516 an alternative wire(s) is determined, based on the maintained AW-relevant information that is associated with the predetermined pattern Z.

The determination of correspondence between a sub-network of the Boolean network and one of the predetermined design patterns may be done in any competent manner. In some embodiments of the method 510, the determination of correspondence is performed by performing graph pattern matching using conventional graph matching techniques. (Graph pattern matching is a well-known conventional art.) Preferably techniques for speeding up the graph pattern matching are used. For example, preferably

In one embodiment of the method 510, the predetermined design patterns are stored as sub-graph configurations having nodes and edges with certain characteristics. For example, the nodes may be characterized very simply by a triplet of information, as will be further discussed in a later section. Preferably, the predetermined design patterns are constrained in the maximum distance (e.g., 2 edges apart) between their alternative nodes and the (target) nodes that are replaced by the alternative nodes. Preferably, then, the search of the Boolean network, if a target node is given, only involves a sub-network around the target node that is commensurate in size as compared to the maximum size of the predetermined design patterns. Optionally, the sub-network around the target node is first “reduced” and then an alternative wire is sought for the target wire using the reduced Boolean sub-network for greater efficiency. Reduction of a network will be further discussed.

The method 510 may be configured as an embodiment of the method 410 of FIG. 4. If so implemented, then preferably, no Boolean implication is performed at all for determining the alternative wire for a target wire. Alternatively, however, as discussed above, if someone chooses to additionally perform some amount of Boolean implication, then preferably no more than 19/20, or no more than 9/10, or no more than ½ of the time spent to find the alternative wire for a target wire is spent performing steps for Boolean implication, on average for at least a logic design for a user.

B. System for Using Pre-Analyzed Logic Patterns for AW

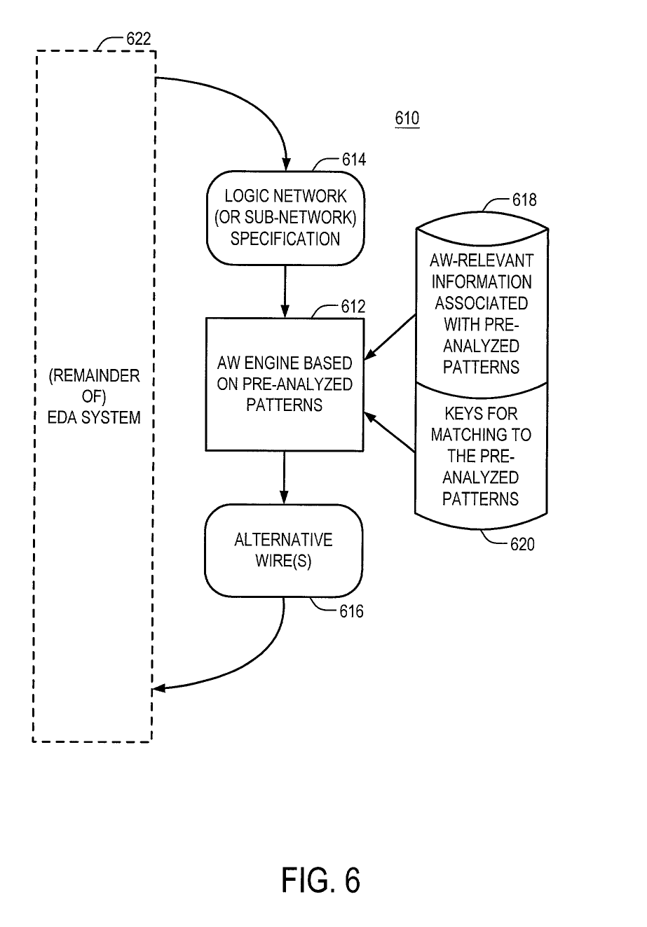

FIG. 6 is a schematic block diagram of an AW system 610 according to the present invention. The AW system 610 uses knowledge gained from pre-analyzed logic patterns to determine alternative wires. The AW system 610 is capable of implementing the method 510 of FIG. 5. As shown, the AW system 610 includes a core AW engine 612. The AW engine 612 accepts or possesses information 614 regarding a logic network for which an alternative wire is sought. The information 614, for example, may be a specification of the logic network using any competent representation format. Preferably, the AW engine 612 also receives or possesses a designation of a target wire(s) within the logic network. Based on the information 614 about the logic network, and preferably also on the designation of the target wire(s), the AW engine 612 determines an alternative wire(s) 616.

In performing its analysis, the AW engine 612 uses pre-stored AW-relevant information 318 that is associated with pre-analyzed logic patterns. The AW engine 612 identifies certain of the AW-relevant information 618 as describing or corresponding to features of the logic network that is described by the information 614. For example, the certain AW-relevant information 618 may correspond to a local sub-network that includes one of the target wire(s). Based on the identified correspondence, the corresponding AW-relevant information indicates alternative wire(s) for the one of the target wire(s).

As has been mentioned in connection with FIG. 5, in some embodiments of the present invention, pattern matching is used to match sub-networks in the logic network described by the information 614 with pre-stored, pre-analyzed logic patterns 618. More generally, the AW system 610 maintains keys 620 by which features or portions of the logic network may be matched with information 618 that indicate position of alternative wires for such features or portions of the logic network. In the pattern-matching embodiments of the present invention and of the system 610, the keys 620 for the pre-stored, pre-analyzed logic patterns are merely the graph representation of the logic patterns themselves; the AW-relevant information 618 are information indicating positions of alternative wires within each pre-stored, pre-analyzed logic pattern; and the information 614 include the graph representation of the logic network or sub-network.

As shown in dashed lines in FIG. 6, the inputs and outputs of the AW engine 612 are communicated with the (remainder) 622 of an EDA system for use for EDA applications.

VI. Example Embodiment: Design Using Pre-Analyzed Building Blocks

In logic design, libraries of previously designed logic modules or building blocks are frequently used. Such logic building blocks are sometimes referred to as macros or macro-cells and typically include many gates and perform possibly complex functions.

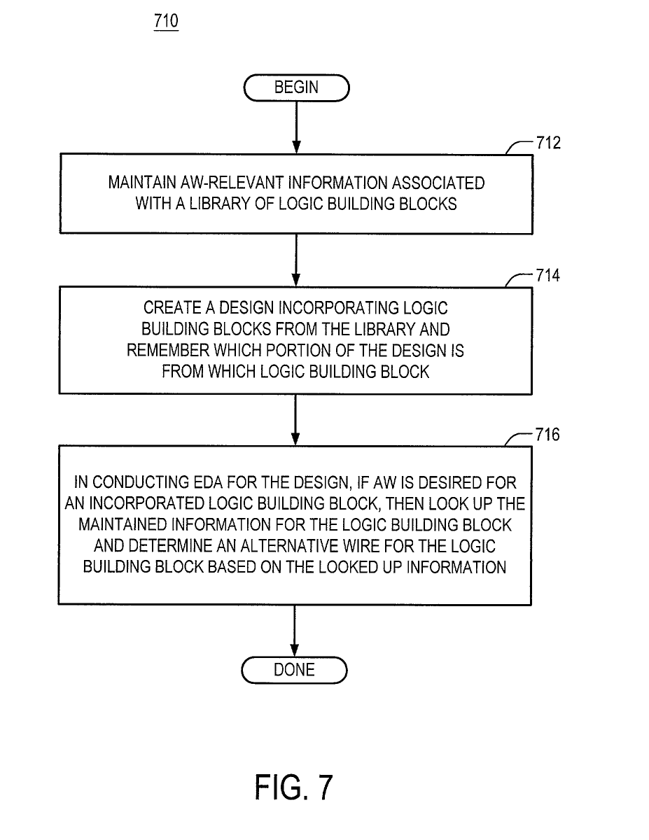

FIG. 7 is a schematic flow diagram that illustrates a method 710 according to an embodiment of the present invention, that maintains and uses AW-relevant knowledge of logic building blocks in order to much more efficiently and quickly determine alternative wires for the logic networks built from the logic building blocks. As shown, in a step 712, AW-relevant information is maintained for each of multiple logic building blocks of a library. Such AW-relevant information may be obtained, for example, by pre-analyzing the logic building blocks using any competent AW methods, for example, RAMBO or the pattern-matching embodiment of method 510 of FIG. 5 or any other suitable method. In a step 714, a logic network is built using such building blocks, and a record is kept for the logic network that identifies which of its portions came from which logic building block. Thereafter, in a step 716, if the logic network is in need of alternative wire(s), then the alternative wire(s) for portions of the logic network can simply be looked up. Not only is Boolean implication not needed for each alternative wire determination, but even pattern matching is not initially needed for those target wires that come from a logic building block. Instead, mere table look-up can be used.

For example, given a target wire, an AW engine according to the present invention merely looks in a table for the logic design to learn that the target wire came from a logic building block “Q”. Then, the AW engine looks in a table for the library of logic building blocks to access the AW-relevant information for the logic building block “Q”. If the AW-relevant information indicates that the target wire has an already-known alternative wire, then that alternative wire can be considered for use. Optionally, if the table lookup procedures produces an acceptable alternative wire, then no other AW method is used, but only if the table lookup procedures fail to produce an acceptable alternative wire then another, more slow method is used, for example the pattern-matching embodiment of method 510 of FIG. 5.

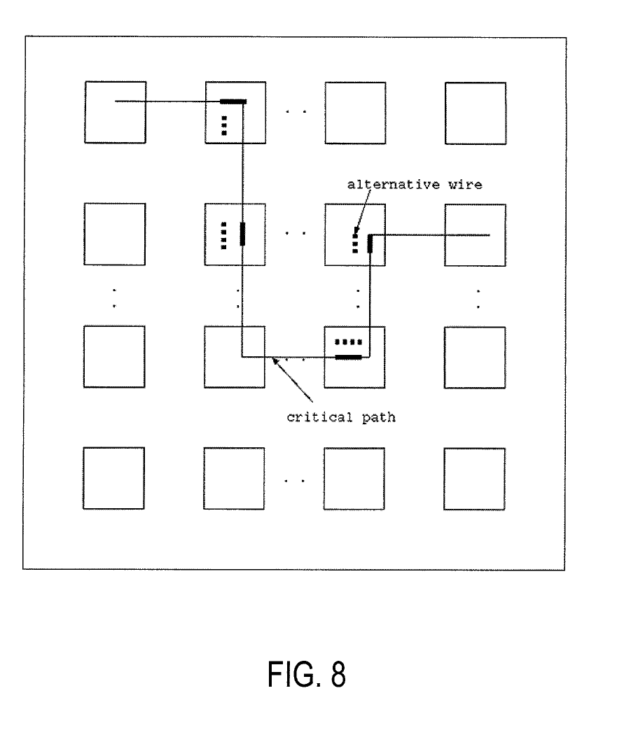

FIG. 8 is a schematic block diagram that illustrates an example logic design built using pre-analyzed logic building blocks with known AW properties.

VII. Embodiment Details: Using Pattern Matching To Handle Arbitrary Designs

A. Preliminary Remarks and Terminology

The existence of alternative wires for any given 2-level Boolean network and a target wire is NP-complete. Consider a Boolean function ƒ(x₁, . . . , xₖ) with SOP form c₁+ . . . +cₖ, construct a 2-level Boolean network G as follows. Let each variable xᵢ corresponds to a node xᵢ, plus an extra input node x₀. For each product cᵢ add a 1-level node with operator AND, and add a 2-level node ƒ with operator OR; then join xᵢ to cⱼ if (xᵢ)′ is a variable of xᵢ and insert an INV node if the literal of xᵢ in cⱼ is (xᵢ)′, connect cᵢ to ƒ for i=1, . . . , k−1, join x₀ to ƒ and cᵢ for i=1, . . . k. Finally set cᵢ and ƒ as output nodes. Now choose w=(x₀, F) as a target wire. Obviously the only possible alternative wire is w′=(cₖ, F). w′ is an alternative wire is equivalent to c₁+ . . . +cₖ=1. The latter problem is known to be NP-complete.

A Boolean network is a directed acyclic graph, where each node nᵢ is associated with a Boolean function ƒᵢ and a Boolean variable yᵢ. An edge (or wire), denoted by (nᵢ, nⱼ), is said to have tail nᵢ and head nⱼ if the function ƒⱼ depends on the variable yᵢ, and the node nᵢ is called a fan-in of the node nⱼ; the number of fan-in of nⱼ is called the in-degree and written as d⁻⁽nⱼ). nⱼ is called a fan-out of nᵢ; the number of fan-out of nᵢ is called the out-degree and written as d⁺(nᵢ). The level of a node is the maximum number of nodes of in-degree at least two on the paths from that node to an input node. The level of a network is defined to be the maximum of levels of all its nodes.

Vertices correspond to the primary inputs (PI), primary outputs (PO) and the gates of the circuit. PI and PO are nodes which have only outgoing edges and incoming edges respectively. An internal node has at least two incoming edges and one outgoing edge and is associated with a Boolean function. Inverters are not considered as internal nodes, but as polarity of edges. For simplicity, we can assume all the internal nodes to be simple gates, that is AND, OR, NAND or NOR. A wire is replaceable if and only if it has at least one alternative wire.

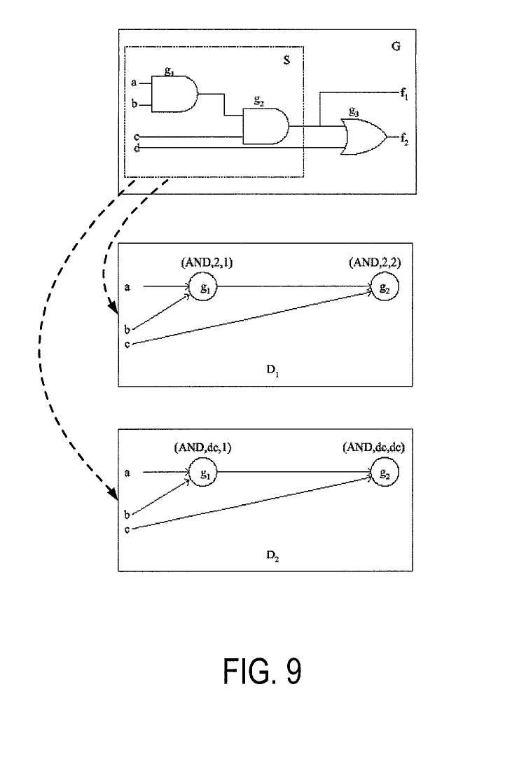

FIG. 9 is a schematic logic diagram that illustrates a mapping of a sub-network of a logic network to various configurations. We use a graph configuration D to map the logic function from a Boolean Network G. For each node ni in sub-network S in network G, ni is mapped to a triplet (op, i1, i2) in D where op denotes the operator representing the boolean function of ni and i1, i2 are non-negative integers. All edges inside S are preserved, while the edges outside S are omitted in D. In most cases, i1 equals d−(ni) and i2 equals d+(ni). The element of a triplet (op, d−(y), d+(y)) can also be don't care, dc. For the first element, dc means any operator. For the other elements, dc can be any positive integers. We use a configuration to denote a minimal pattern containing both the target and its alternative wire. S is a sub-network of G. D1 and D2 are called two mappable configurations of S. A configuration denotes a minimal pattern containing both the target and its alternative wire. The k-local pattern denotes the alternative wire pair in the minimal graph with the distance between the alternative wire and the target wire is k. The distance between two wires is defined as the difference of maximum path length from any primary input to each of the wires.

B. Logic Patterns for Use in the Pattern-Matching

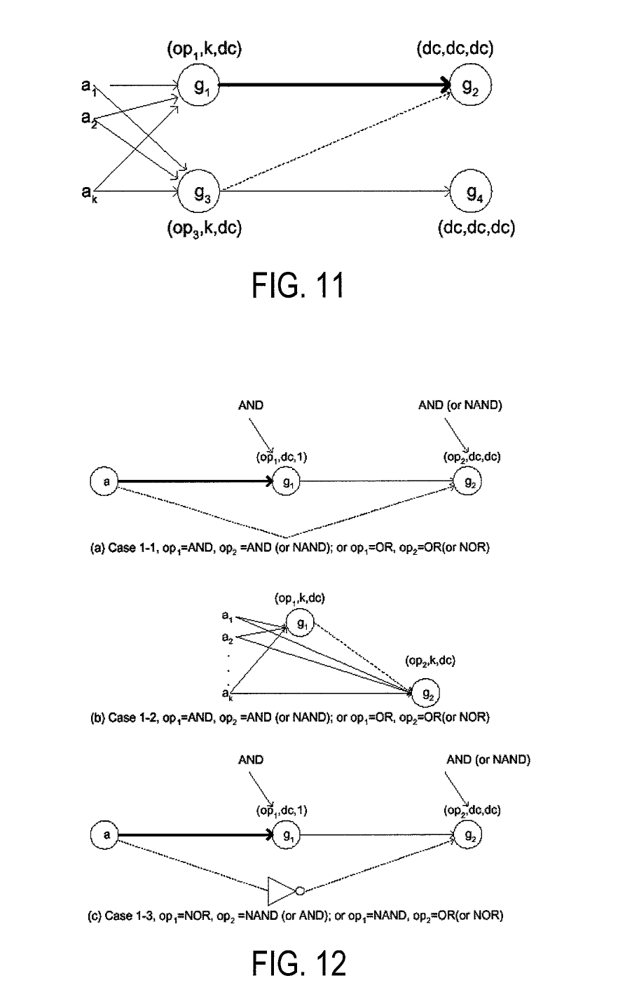

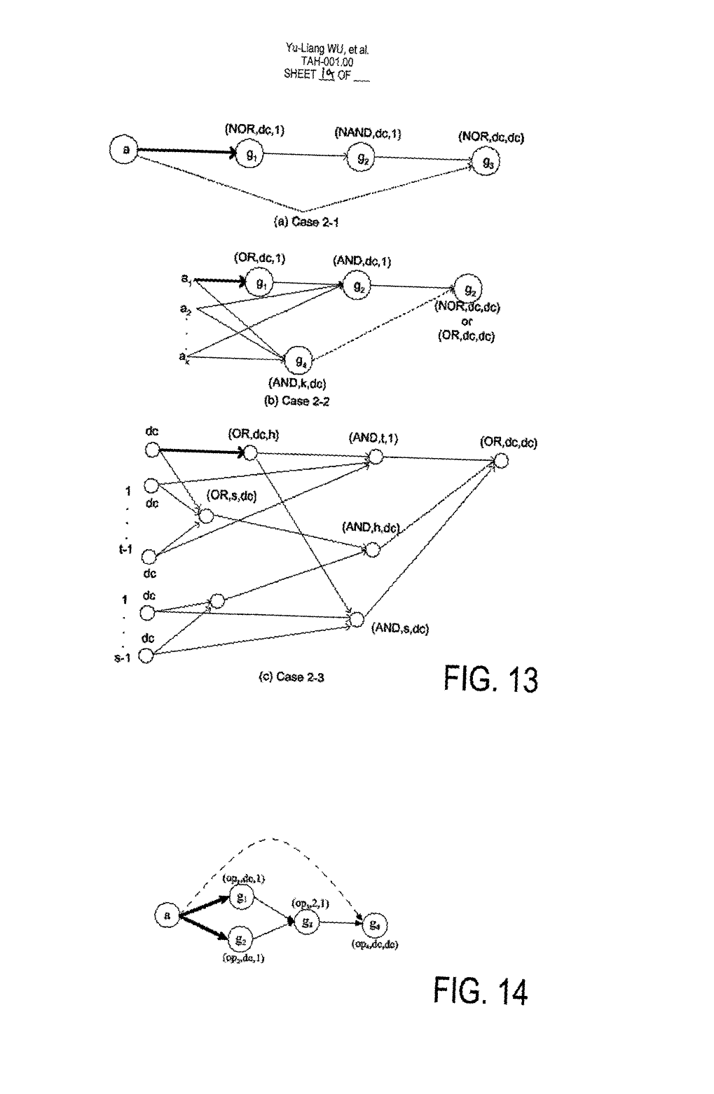

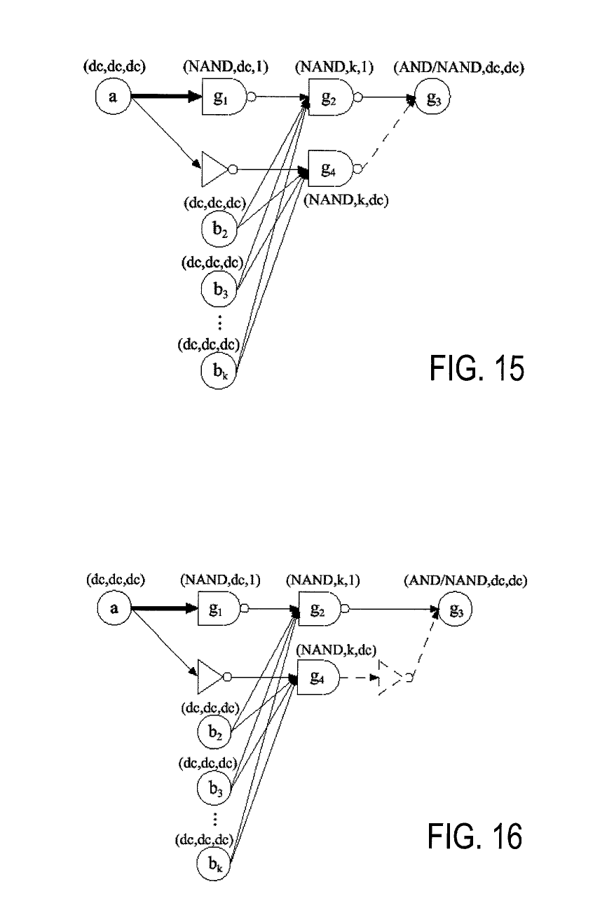

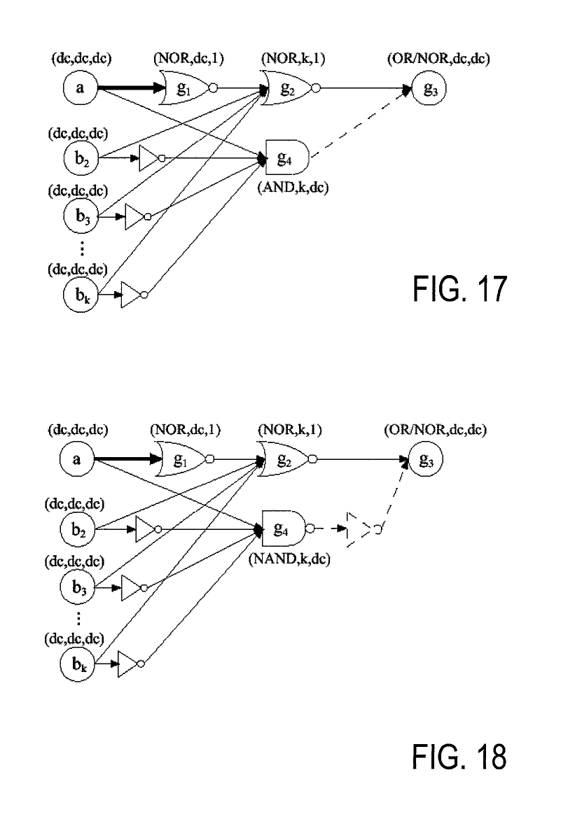

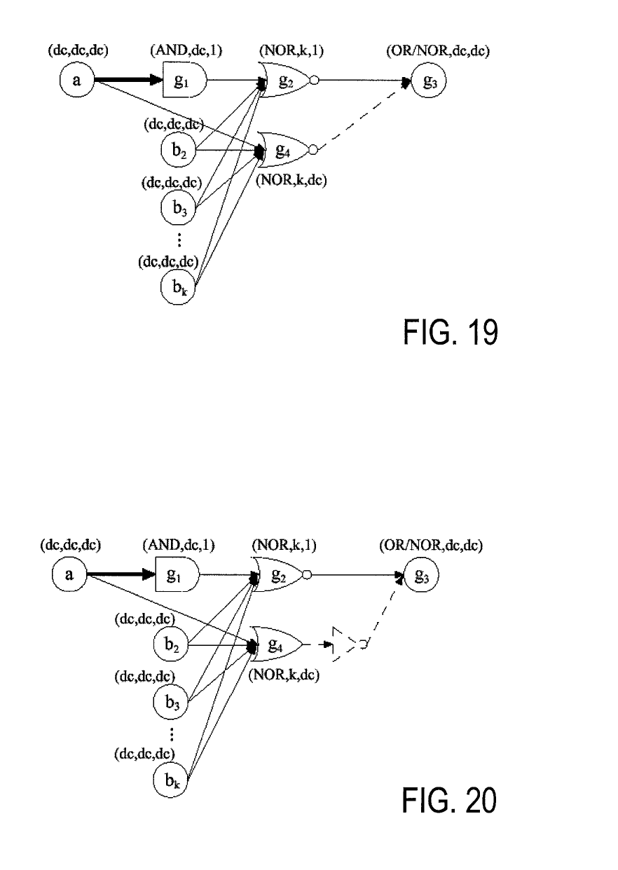

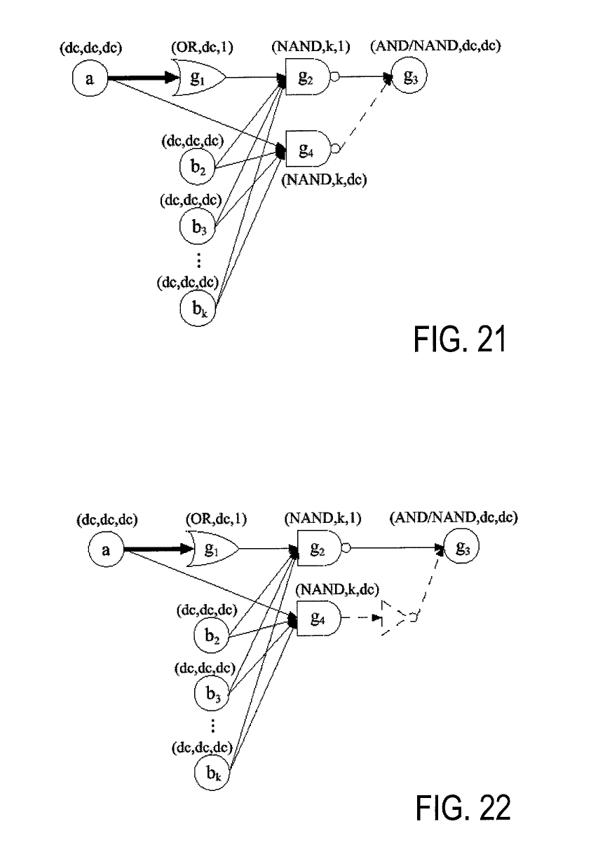

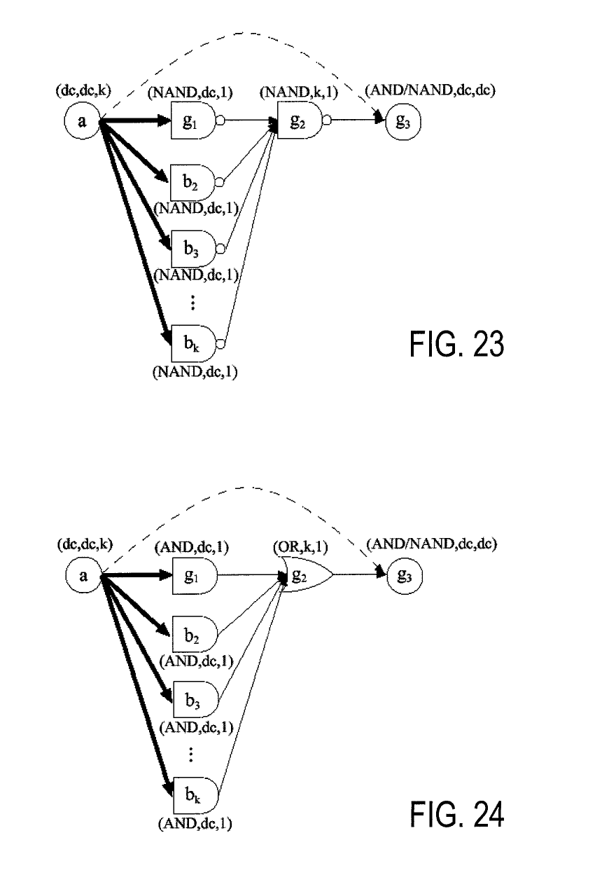

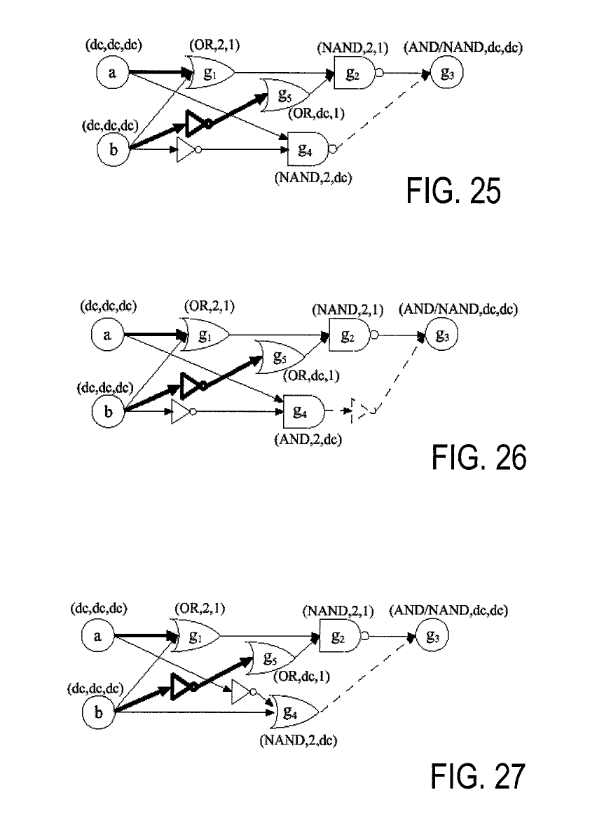

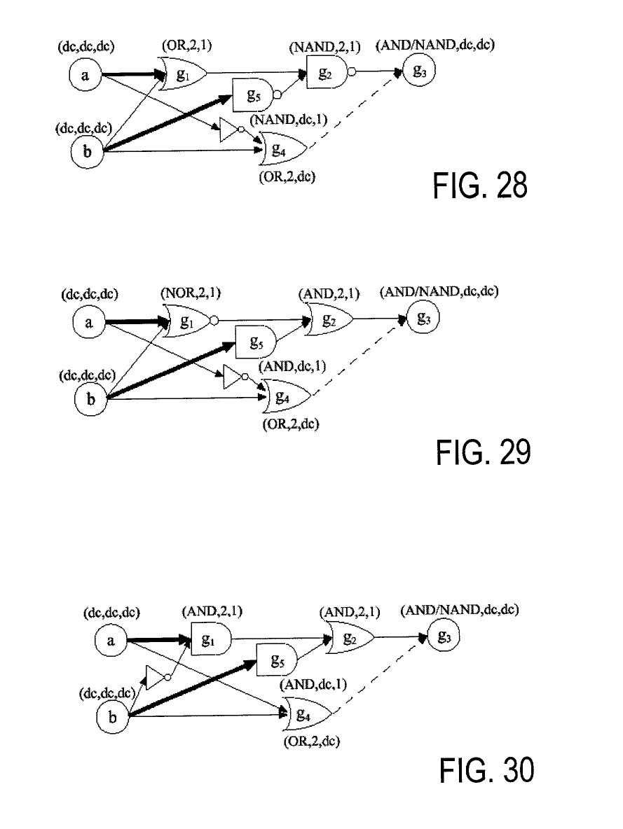

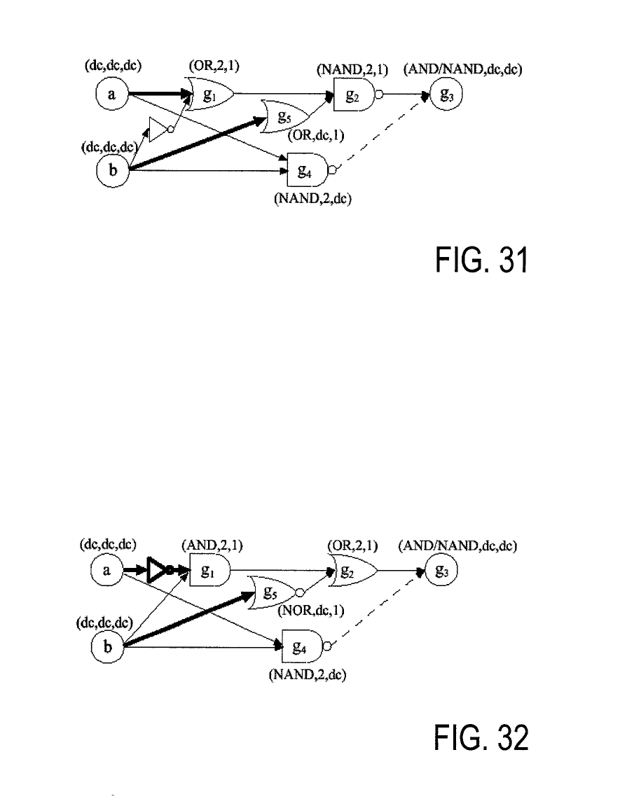

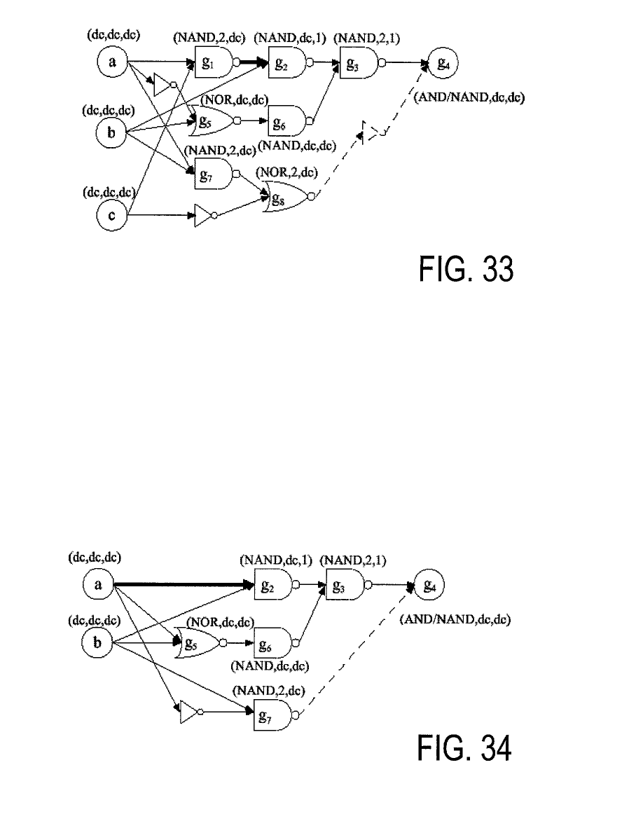

FIGS. 11-34 schematically illustrate an extensive set of useful pre-analyzed logic patterns that indicate alternative wires and target wires. However, it must be understood that any other logical patterns may also be used, and that the present invention is not limited to these or to any particular logical patterns.

In FIGS. 11-34, minimal 0-local, 1-local, and 2-local patterns are presented. Some 2-local patterns are organized into clusters for greater pattern-matching efficiency by the AW method as well as for ease of presentation in the present document. As can be seen, some logic patterns have at least four, or at least eight, gates. Some logic patterns have at least two levels of gates.

We define the complete set of patterns as Pattern Family F and each of the member in the pattern set as Pattern Member P. To systematically analyze the patterns, we introduce another 2 terminologies: Pattern Cluster C and Specific Member S. Pattern cluster C is defined as a subset of F which contains more than one P where the members in the same pattern cluster has the same topological order but the op in each of the node can be different. Specific member S is defined as an individual pattern which cannot group with other pattern in the pattern family F.

C. Further Preliminary Remarks

A Boolean network is a graph presentation of a system of Boolean functions with some specified variables as primary inputs and functions as primary outputs. The system of Boolean functions can be expressed as follows:

Primary inputs:

xᵢ, i=1, . . . , k

y₁=ƒ₁(x₁, . . . , xₖ)

y₂=ƒ₂(x₂, . . . , xₖ, y₁)

y₃=ƒ₃(x₃, . . . , xₖ, y₁, y₂) . . .

yₘ=ƒₘ(x₁, . . . , xₖ, y₁, y₂, . . . , yₘ₋₁) (1)

Primary outputs:

yᵢ₁, . . . , yᵢₕ.

Function y₁=ƒᵢ(x₁, . . . , xₖ, y₁, y₂, . . . , yᵢ₋₁) in (1) with respect to the variables x₁, . . . , xₖ, y₁, y₂, . . . , yᵢ₋₁ is called the local function of y_{i·}ƒᵢ is an operator function if it is obtained by an operator which can have many operands and the order of operands does not matter. For example, AND, OR, EOR are such operators. The function obtained from yᵢ by substitutions until all variables become primary inputs is called the global function of yᵢ. The functionality of a Boolean network is the set of the global functions of primary outputs. Two Boolean networks are equivalent if they have the same functionality. Note that this is a most general version of Boolean networks. Different Boolean networks can be obtained from restriction of functions ƒᵢs to some specific function library such as (AND, OR, INV, NAND, NOR) in the case of combinatorial circuits, and functions with at most k arguments in the case of circuit decomposition for FPGA.

Let e=(n₁, n₂) be a wire of a Boolean network G. An ordered pair of nodes e′=(n′₁, n′₂) is said to be an alternative wire of e if e′ is not a wire of G, e′≠e, the functions at n₂ and n′₂ are operator functions and G−e+e′ has the same functionality as that of G, where G−e+e′ represents the Boolean network obtained by removing e and adding e′.

Here we would only consider Boolean networks with function library {AND, OR, INV, NAND, NOR}. Such a Boolean network can be expressed by a directed graph with an operator assigned to each node. The induced sub-network of G by a subset of nodes S is a directed sub-graph of G, with node set S and the wires that are in G and joining two nodes in S. We call the node with out-degree as a zero terminal node and node with in-degree zero as input node. If a Boolean network has only one terminal node, it is called single terminal network; otherwise it is called multiple terminal network. Each terminal node y of Boolean network corresponds to a unique sub-network induced by all its fan-ins, called the y oriented sub-network. Obviously, a multiple terminal Boolean network is the union of all its terminal oriented sub-networks.

Given an wire w=(nₛ, n_{d}) of a Boolean network G. A sub-network containing w and of level k is called a k-level sub-network. An induced sub-network is called AND (OR) sub-network if it has only one primary output node and has the same operator AND (OR) at all non-input nodes and each inner nodes has out-degree one.

From above arguments we can not expect any efficient algorithm to find any existing alternative wire even for Boolean networks with small levels. However, if we restrict both in-degrees and levels, then the number of Boolean functions is bounded and so that alternative wires can be determined by examining each circuit individually. For practical circuits, the in-degrees and levels must have some bounds, so that it is possible to design efficient algorithms just for these circuits.

D. Reduction of Boolean Networks

RAMBO algorithm can find the existing alternative wire as long as there is enough computing power. The disadvantage of the algorithm is that it is exponential in terms of number of nodes, and the recursive learning of logic implication contributes to the exponential factor.

As was mentioned above, according to an embodiment of the present invention, first some reduction is performed to the network and then alternative wires are sought in the reduced Boolean network by applying an AW method, for example, the pattern recognition embodiment of method 510 of FIG. 5. In general, a reduction with respect to a target wire is a transformation from one Boolean network and target wire (G, w) to another (G′, w′) satisfying that each alternative wire in (G, w) corresponds to an alternative wire in (G′, w′) or w′ when w≠w′, and all alternative wires of (G, w) can be obtained from the alternative wires in (G′, w′). For example, if a Boolean network G with target wire w=(n₁, n₂) contains an AND sub-network N rooted at n in which n₁ is not an inner node of N, then we can shrink N by deleting the inner nodes of N and redirecting the wires of N out of primary input nodes to n. Note that if n₁ is a primary input node of N and n₂ is an inner node of N, then we take (n₁, n) as the target wire of the obtained Boolean network. We will see that shrinking is a reduction. We can do the shrinking to all AND (OR) sub-networks to reduce the number of nodes.

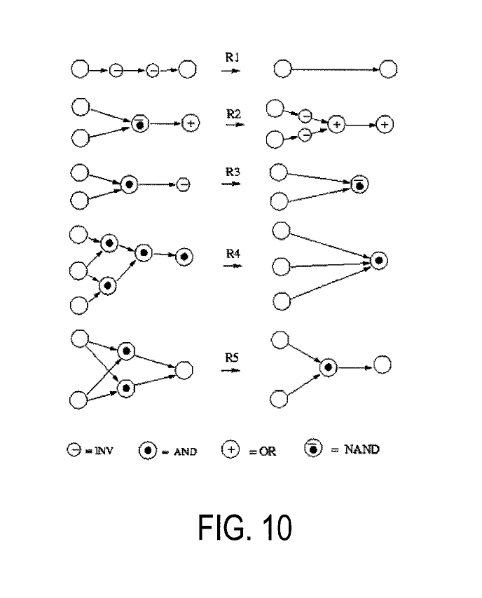

The followings are some simple reduction rules with respect to an alternative wire. FIG. 10 is a schematic logic diagram that shows the transformation by reduction rules:

(R1). Substitute two consecutive INV nodes by a new wire.

(R2). If a NAND (NOR) node n has out-degree one and with an OR (AND) node as fan-out, then change n to an OR (AND) node and insert an INV node to each of its input wires.

(R3). If an AND (OR) node n has out-degree one and with an INV node as fan-out, then combine the AND (OR) and INV node to an NAND (NOR) node.

(R4). Shrink AND (OR) sub-network with respect to target wire.

(R5). If two nodes with the same function operator and the same neighbors, then delete one of them which is not incident with the target wire.

We take the new wire as a target wire if the original target wire is changed in R1 though R2. Note that if the head or tail of the target wire is changed in the transformation, then target wire in the new network corresponds to some alternative wires in the original network. It can be proved that the rules R1 through R5 are valid and that R4 can be performed in linear time.

E. Another Application Illustration

Here, we give a logic minimization example to illustrate the usage of the GBAW technique. By examining the pattern configurations in terms of wire addition and removal, they can be further classified in Perturbation Phase and Simplification Phase.

The first phase is called the Perturbation Phase, mainly concentrate on searching for candidate patterns for possible simplification result. Upon a match, alternative wires would be added. As a result, circuit is said to be “perturbed”. This prepares the circuit for the next phase on minimizing the logic design.

The next phase, called Simplification Phase, mainly serves on simplifying the circuit to a more scaled-down version. The engine would remove target wires according to configurations of those matched patterns. Circuit logic is minimized while maintaining the same functionality.

By separating these two phases, the main engine can have the Perturbation Phase focused on searching for any matched pattern for adding in alternative wires. The perturbed circuit is very likely to have a corresponding pattern in the Simplification Phase that can remove target wires according to perturbed configurations. Also, the Simplification Phase has the advantage of scanning through all possible candidates and choosing appropriate simplification.

F. Partial Pattern Matching Technique

In local pattern matching, many would consider it as a straightforward process, making the success rate depend heavily on the design of pattern configurations. For each pattern, when applied on benchmark circuits, usually have very strict fan-in & fan-out restrictions, e.g. 2 fan-in pattern in SIS software.

However, There are cases that the pattern can still be matched upon loosened restrictions and subjected to both phase in engine run time.

The original GBAW searches by following the nodes in depth-first-search manner. If one node does not match exactly (e.g. node type; fan-in/out limitation), the function will return failure and proceed on next search on next node.

This restriction limits the number of patterns to be found. We suggest loosening the restriction so we can find more candidates that can be simplified after Perturbation Phase.

G. Reverse Matching

Alternative wires and target wires are always in pair. If we add wire a for removing b, we should be able to add b for removing a. To implement reverse search, the run down process of each pattern matching would be doubled, one for examining from straight order, and the other in reverse order.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. In an information processing system, a method for alternative wiring for logic design, the method comprising:
maintaining information descriptive of alternative wiring for each of multiple predetermined logic patterns;
for a logic network, determining a portion of the logic network as corresponding to one of the multiple predetermined logic patterns; and
determining an alternative wire for the logic network based on information maintained in the maintaining step that is descriptive of alternative wiring for the one of the multiple predetermined logic patterns.

2. The method according to claim 1, wherein the determining steps do not include performing Boolean implication.

3. The method according to claim 1, wherein the determining steps include performing Boolean implication, and the performing of steps for Boolean implication is limited to an amount that takes no more than 19/20 of all time required by the method to identify an alternative wire given a target wire, on average for a logic network for a user.

4. The method according to claim 3, wherein the amount is an amount that takes no more than 9/10 of all time required by the method to identify an alternative wire given a target wire, on average for a logic network for a user.

5. The method according to claim 1, wherein the step of determining a portion of the logic network as corresponding to one of the multiple predetermined logic patterns comprises pattern-matching a graph of the portion of the logic network to a graph of the one of the multiple predetermined logic patterns.

6. The method according to claim 1, wherein:
the predetermined logic patterns include patterns associated with logic building blocks used in logic design;
the logic network was designed using at least some of the logic building blocks; and
the step of determining a portion of the logic network as corresponding to one of the multiple predetermined logic patterns comprises realizing that the portion of the logic network was designed using a logic building block with which the one of the multiple predetermined logic patterns is associated.

7. A system for alternative wiring for logic design, the system comprising:
means for maintaining information descriptive of alternative wiring for each of multiple predetermined logic patterns;
means for determining, for a logic network, a portion of the logic network as corresponding to one of the multiple predetermined logic patterns; and
means for determining an alternative wire for the logic network based on information maintained by the means for maintaining that is descriptive of alternative wiring for the one of the multiple predetermined logic patterns.

8. The system according to claim 7, wherein the two means for determining do not include means for performing Boolean implication.

9. The system according to claim 7, wherein the two means for determining include means for performing Boolean implication that is configured to perform only so much Boolean implication as to take no more than 19/20 of all time required by the system to identify an alternative wire given a target wire, on average for a logic network for a user.

10. The system according to claim 7, wherein the means for performing Boolean implication that is configured to perform only so much Boolean implication as to take no more than ½ of all time required by the system to identify an alternative wire given a target wire, on average for a logic network for a user.

11. The system according to claim 7, wherein the means for determining a portion of the logic network as corresponding to one of the multiple predetermined logic patterns comprises means for pattern-matching a graph of the portion of the logic network to a graph of the one of the multiple predetermined logic patterns.

12. The system according to claim 7, wherein:
the predetermined logic patterns include patterns associated with logic building blocks used in logic design;
the logic network was designed using at least some of the logic building blocks;
the means for determining a portion of the logic network as corresponding to one of the multiple predetermined logic patterns makes its determination based on realizing that the portion of the logic network was designed using a logic building block with which the one of the multiple predetermined logic patterns is associated.

13. A method for computer-aided design, comprising:
determining a logic design including selecting predetermined logic building blocks for inclusion into the logic design, wherein the predetermined logic building blocks have been pre-analyzed for alternative wiring, and alternative wiring information is available for the predetermined logic building blocks;
recording retrieval information for a portion of the logic design that is from one of the predetermined logic building blocks, wherein the retrieval information enables later look-up of alternative wiring information for the portion of the logic design, wherein the alternative wiring information for the portion of the logic design is from the alternative wiring information that is available for the predetermined logic building blocks.
